(19) United States
(12) Patent Application Publication
(10) Pub. No.: US 2011/0315430 A1
(43) Pub. Date: Dec. 29, 2011

(54) CABLE MANAGEMENT SYSTEM FOR CABLE AND WIRE STORAGE

(76) Inventor: Steve Livingston Wint, Coral Springs, FL (US)

(21) Appl. No.: 12/975,394

(22) Filed: Dec. 22, 2010

Related U.S. Application Data
(60) Provisional application No. 61/290,674, filed on Dec. 29, 2009.

(51) Int. Cl. H01B 7/00

(52) U.S. Cl. 174/135

(57) ABSTRACT

A cable management system for use in storing loose or dangling cables and wires of electronic devices behind a stand. A flexible storage receptacle affixed to a stable surface via suspension cables and fasteners. Cables and wires may be places within the receptacle so that they are not exposed to viewing.

### CROSS-REFERENCES TO OTHER APPLICATIONS

Provisional application No. 61/290,674, filed on Dec. 29, 2009.

### STATEMENT REGARDING FEDERALLY SPONSORED RESEARCH OR DEVELOPMENT

Not Applicable

### REFERENCE TO SEQUENCE LISTING

Not Applicable

### BACKGROUND OF THE INVENTION

1. Field of the Invention

The present invention relates to improved methods and apparatus for managing electronic cables and wires. More particularly, the present invention relates to a cable management system that can be used to house loose or dangling cables and wires out of direct sight.

2. Background of the Invention

Throughout recent years there has been an increase in the number of devices that accompany television sets in the entertainment area of people's homes. Those include additional audio-video equipment, video game consoles, digital video recorders, etc. The additional electronic devices also come with additional cables and wires, most of which dangle behind a table or stand, this can be unsightly and potentially hazardous.

Dangling and loose cables or wires may pose a hazard to small children and pets. Without proper supervision, they may get tangled in the wires and this may lead to strangulation, causing serious injury or even death. Once a child or pet gets behind a television stand, they will have access to any number of loose cables or wires.

For raised stands the appearance of loose cables and power wires can be an unsightly mess. The same can be said for stands that are not placed against a wall where people are free to walk behind it. An effective cable management system will also provide an aesthetically pleasing appearance to the entertainment system by hiding the majority of the wiring used to connect or power the various devices.

### BRIEF SUMMARY OF THE INVENTION

The present invention accommodates for loose or dangling cables and wiring from devices behind a stand, by providing a stable receptacle and anchor system where they can be housed. The invention consists of a flexible receptacle suspended by static suspension cables with both ends attached to an elastic suspension cable with a fastener at one end where it can be attached to a stable surface. In one embodiment of the invention, loose or dangling cables/wires can be places within the receptacle so that they are not exposed to viewing. The receptacle may also contain openings at the bottom to facilitate running cables or wires through.

### BRIEF DESCRIPTION OF DRAWINGS

FIG. 1 is a front view of the present invention.

FIG. 2 is a cut-away cross-section view of present invention.

FIG. 3 is an interior front view of the preferred embodiment of present invention.

### DETAILED DESCRIPTION OF THE DRAWINGS AND PREFERRED EMBODIMENT

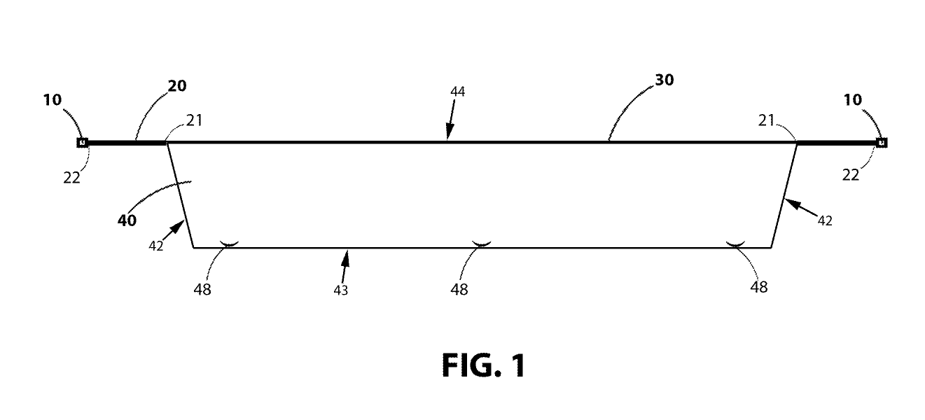

FIG. 1 is a perspective view of a cable management system, the present invention. Visible components of the static suspension cables 30, the storage receptacle 40, the elastic suspension cables 20, and the fastener ends 10. The full length of the storage receptacle 40 may run the entire length of the static suspension cables 30. The elastic suspension cables 20 is generally shorter in length to the static suspension cables' 30 length. The static suspension cables 30 may be fully encapsulated by the upper folds of the receptacle 40. The storage receptacle 40 may also exhibit openings 48 at the lower area to facilitate access to wires within the receptacle.

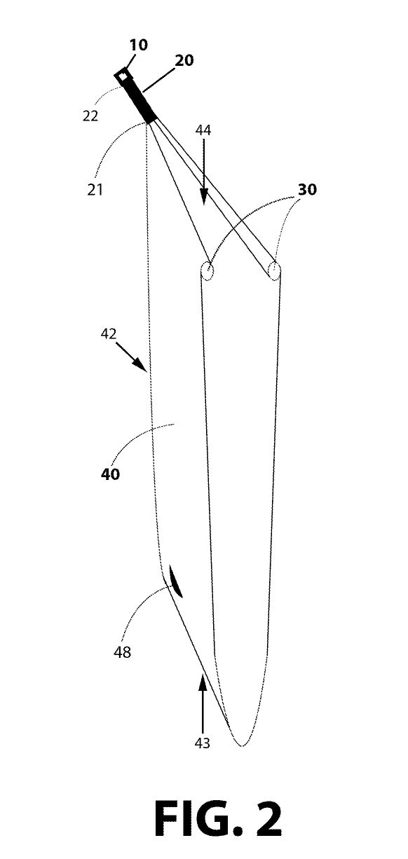

FIG. 2 illustrates a cut-away cross-section view of the present invention. The figure further highlights the partially encased static suspension cable 30 within the storage receptacle 40. The flexible storage receptacle 40, resembling an elongated pocket, is closed on both sides 42 and bottom 43, with an opening at the top 44. The outer ends of the static suspension cables 30 are shown attached 21 to one end of the elastic suspension cable 20 used to provide the necessary tension and adjustable extension of the system. At the far end of the elastic suspension cable 20 an attachment 22 is made to the fastener 10 so that the system can be attached to a stable surface.

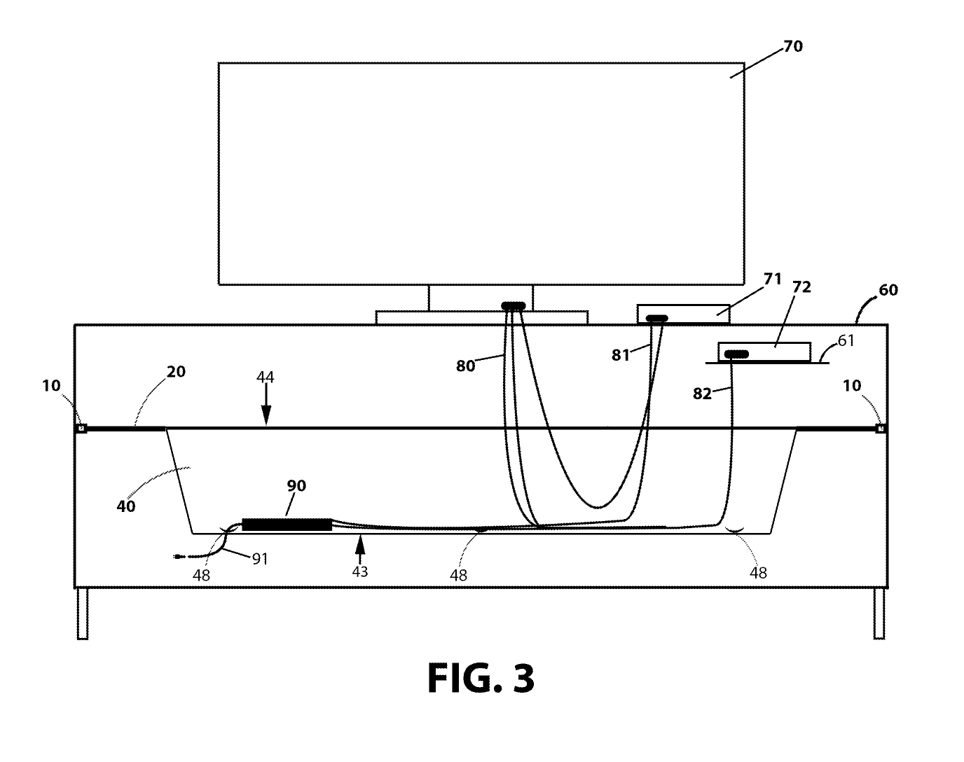

FIG. 3 is an internal front view of the preferred embodiment of the present invention, showing the cable management system secured to the stable surface of the stand 60 by the fasteners 10. The television 70 that is placed above the stand 60 along with a peripheral device 71. Additional peripheral device(s) 72 may be placed inside the cabinet compartment 61 of the stand with the wire(s) 82 exposed through the back. The television's wire 80 as well as the wires from the peripheral devices 81,82 can enter the top of the storage receptacle 44 and lay along the bottom interior lining of the receptacle 43. A power strip 90 may also be placed inside the receptacle with the main wire 91 going through the access opening 48 to an outlet. With the cables and wires stored securely inside the receptacle they will be out of view.

The invention claimed is:

1. A cable management system for storing loose or dangling cables and wires comprising:
a storage receptacle;
at least one static suspension cable used to support the storage receptacle;
at least one elastic suspension cable;
fasteners to attach the storage system to a stable surface.

2. A cable management system as claimed in 1 in which the receptacle is in the shape of an elongated pocket, that is sealed on the bottom portion and an opening at the top and may be sealed on the sides.

3. A cable management system as claimed in 1 where the storage receptacle is composed of a flexible material to adjust for the shapes of its content.

4. A cable management system as claimed in 3 and further including at least one access opening close to the bottom of the storage receptacle.
